(19) United States
(12) Patent Application Publication
(10) Pub. No.: US 2010/0263321 A1
(43) Pub. Date: Oct. 21, 2010

(54) ACOUSTIC MOUNT

(76) Inventors: Benjamin Gordon Stevens, Victoria (AU); Kurt Schnepf, Victoria (AU)

Correspondence Address: FASTH LAW OFFICES (ROLF FASTH), 26 PINECREST PLAZA, SUITE 2, SOUTHERN PINES, NC, 28387-4301, US

(21) Appl. No.: 12/825,100

(22) Filed: Jun. 28, 2010

Related U.S. Application Data
(63) Continuation of application No. 11/872,574, filed on Oct. 15, 2007, now abandoned.

(30) Foreign Application Priority Data
Oct. 16, 2006 (AU) 2006905693

(51) Int. Cl. E04B 1/82; F16M 13/00; B23P 11/00

(52) U.S. Cl. 52/741.1; 29/428

(57) ABSTRACT

There is disclosed an acoustic mount for dampening vibrations between two structures mounted or coupled in use to each other. The mount includes a vibration dampening member having a first portion, a neck and a second portion. The second portion has a head. The dampening member has a bore running through the first portion, neck and head to receive a component, such as a fixing member such as a screw, for engaging or coupling to a first one of the two structures. A support member is also described to which a second one of the two structures is secured or coupled in use. The support member has an aperture to receive the dampening member. The dampening member is an integral unit and the head can be passed through the aperture and positioned such that said head resists withdrawal through the aperture. The support member is interposed between the first portion and the second portion.

### CROSS-REFERENCE TO RELATED APPLICATIONS

The present application is a continuation patent application from U.S. patent application Ser. No. 11/872,574 filed 15 Oct. 2007 that claims priority from Australian Provisional Patent Application No 2006905693 filed on 16 Oct. 2006.

### TECHNICAL FIELD

The present invention relates to an acoustic mount which may be used in applications where it is desirable to reduce transmission of acoustic vibrations from one area to another. The acoustic mount of the invention may have applications for example in industrial, automotive or building environments.

### BACKGROUND

Vibrations are transferred between structures, such as walls and the like, via abutting or connecting points. In the building industry, for example, external masonry walls are often clad internally with thinner plaster board walls which are secured at mounting or connecting points to the external wall. Noise travels from the masonry wall via these connecting points to the plaster board walls and vice versa. A similar situation occurs internally between adjacent areas or rooms where noise is transferred by connecting points between internal wall components. Likewise vibrations travel between industrial machinery and its housings and its mountings, and between automobile engines or other vibration sources and the vehicle body and vehicle interior via connecting points.

There are products used in the building industry to dampen transfer of vibrations at connecting points on walls, or between a floor and its support structure, or between a structure and a cladding. These products include a resilient sound dampening pad between one structure and a bracket that, in use, is mounted to an adjacent structure.

One example mount is that disclosed in Australian patent number 758716. This discloses an acoustic mount assembly comprising three assembled parts; a pad, a bracket and a metal bush. The mount assembly comprises an acoustic pad with an integral sleeve extending at right angles. The sleeve has a thread on its external surface. The pad is mounted in an opening on the bracket by screwing the sleeve into the opening. The metal bush, which comprises a tubular portion and a flange, is inserted into the rubber sleeve to complete assembly of the mount. The fixing member, such as a screw, passes through the bush in use.

Another known mount also comprises three parts, a pad with a sleeve, a bracket and an annular cap which fits onto the sleeve to complete the assembly after being passed through an aperture in the bracket.

The above references to and descriptions of prior proposals or products are not intended to be, and are not to be construed as, statements or admissions of common general knowledge in the art in Australia.

### SUMMARY OF THE INVENTION

The present invention in a first aspect provides an acoustic mount for dampening vibrations between two structures mounted or coupled in use to each other, said mount including:

a. a vibration dampening member having a first portion, a neck and a second portion, said second portion comprising a head, and said dampening member having a bore running through said first portion, neck and head to receive a component, such as a fixing member such as a screw, for engaging or coupling to a first one of the two structures; and

b. a support member to which a second one of the two structures is secured or coupled in use, said support member having an aperture to receive said dampening member;

wherein said dampening member is an integral unit and said head can be passed through said aperture and positioned such that said head resists withdrawal through the aperture and that said support member is interposed between said portions.

When used in this specification, including the claims, the term “structure” is intended and is to be interpreted to include not only structural elements which are rigid and provide structural strength but also structures or component elements which are part of a multi-part or complex system and through which vibrations can be transmitted but which do not necessarily provide any rigidity or serve purposes involving structural strength. For example, in suspended ceilings in buildings, ceiling panels or elements can be suspended by rods or wires and the acoustic mount of the invention can be applicable where each of such rods comprises one of the structures, or perhaps two rods meeting end to end constitute the structures with the acoustic mount interposed between the ends. Other types of structures in the building industry with which the acoustic mount of the invention can be used include ceilings, floors, walls (including structural strength walls, infill walls, partition walls), any types of cladding both internal and external e.g. plaster board, villa board.

In one possible embodiment, the aperture of the support member is non-circular and the head is shaped to pass through the aperture and then, upon rotation by less than 360°, to resist withdrawal through the aperture.

The first portion may comprise a resilient pad to dampen vibration transmission therethrough between the first one of the two structures and the support member.

In one form, the head may have therein an embedded washer with a central hole aligned with the bore and the washer resists excessive travel of the fixing member through the bore during use of the mount.

In another form, the vibration dampening member may have therein an embedded receiver member that extends between said first portion, neck and said second portion, said receiver member having a central bore that aligns with the bore of the vibration dampening member and a head portion that is received within the head of the second portion of the vibration dampening member, the head portion thereby resists excessive travel of the fixing member through the bore of the vibration dampening member during use of the mount. The vibration dampening member may comprise a vibration dampening material formed about the receiver member such that the receiver member is substantially encapsulated within the vibration dampening material. The vibration dampening material may be moulded about the receiver member. The vibration dampening material may be a polymeric material, such as a rubber material, and may be formed about the receiver member through a process of vulcanisation.

The head may be oblong in shape and the aperture may be correspondingly shaped. For example, the aperture may be rectangular or generally rectangular with rounded corners.

The present invention also provides in a second aspect a method of assembling an acoustic mount comprising a vibration dampening member and a support member, the vibration dampening member being an integral unit having a first portion, a neck, a second portion and a bore, said second portion comprising a head and said bore being adapted to receive component such as a fixing member running through said first portion, neck and second portion, and the support member having an aperture,

wherein said method comprises passing said head through the aperture and rotating said dampening member less than 360° around the axis of the bore such that said support member is interposed between said first and second portions and said head resists separation of the dampening member from the supported member.

The present invention also provides in a third aspect a building structure having means for dampening sound vibrations travelling from a first structure of the building to a second structure of the building wherein said first and second structures are connected at connecting points, said building structure having at each of said connecting points an acoustic mount for dampening vibrations travelling between the first and second structures, said mount including:

a. a vibration dampening member having a first portion, a neck and a second portion, said second portion comprising a head, and said dampening member having a bore running through said first portion, neck and head receiving a component, such as a fixing member such as a screw, engaging or coupling to said first structure; and

b. a support member to which said second structure is secured or coupled, said support member having an aperture receiving said dampening member;

wherein said dampening member is an integral unit and said head has been passed through said aperture and positioned such that said head resists withdrawal through the aperture and said support member is interposed between said portions,

wherein said component, such as the fixing member, extends through said bore to engage or couple to said first structure, and said second structure is connected to said support member directly or indirectly.

In a preferred use in the building field, the first structure comprises a structural wall or floor of the building and said second structure comprises an internal wall or ceiling spaced from and mounted by the structural wall or floor.

According to yet another aspect, the present invention comprises a vibration dampening member, comprising:

a body having a first portion, a neck and a second portion, said second portion comprising a head and said body having a bore extending through said first portion, neck and head; and

a receiver member embedded within said body so as to extend between said first portion, neck and said second portion, said receiver member having a central bore that aligns with the bore of the body and a head portion that is embedded within the head of the second portion of the body.

The body may comprise a vibration dampening material formed about the receiver member such that the receiver member is substantially encapsulated within the vibration dampening material. The vibration dampening material may be moulded about the receiver member. The vibration dampening material may be a polymeric material, such as a rubber material, and may be formed about the receiver member through a process of vulcanisation.

The receiver member may comprise a cylindrical portion that extends transverse to said head portion so as to extend through said neck and first portion of the body.

### BRIEF DESCRIPTION OF THE DRAWINGS

Possible and preferred features of the present invention will now be described with particular reference to the accompanying drawings. However it is to be understood that the features illustrated in and described with reference to the drawings are not to be construed as limiting on the scope of the invention.

In the drawings:

FIG. 1 is a side view of a mount of a first embodiment of the present invention assembled with a support member in sectional view and in use in a building.

FIG. 2 is a plan view of the mount of FIG. 1.

FIG. 3 is a section view taken along the line A-A of FIG. 2.

FIG. 4 is a top plan view of the vibration dampening member.

FIG. 5 is an underneath plan view of the opposite side of the vibration dampening member shown in FIG. 4.

FIG. 6 is a plan view of the support member.

FIG. 7 is a perspective view of the vibration dampening member positioned preparatory to assembly with the support member.

FIG. 8 is a view of the vibration dampening member in the direction of arrow B in FIG. 7.

FIG. 9 shows a second embodiment of a mount in exploded view similar to FIG. 7.

FIG. 10 shows a third embodiment of a mount in exploded view similar to FIG. 7.

FIG. 11 is a side sectional view of a fourth mount for a suspended support system.

FIG. 12 is a cross-sectional side view of an alternative embodiment of a vibration dampening member of the present invention.

FIGS. 13A and 13B show top and side views respectively of an inner receiver member of the vibration dampening member of FIG. 12.

FIG. 14 shows a top view of an alternative embodiment of vibration dampening member in accordance with the present invention.

### DETAILED DESCRIPTION OF EMBODIMENT

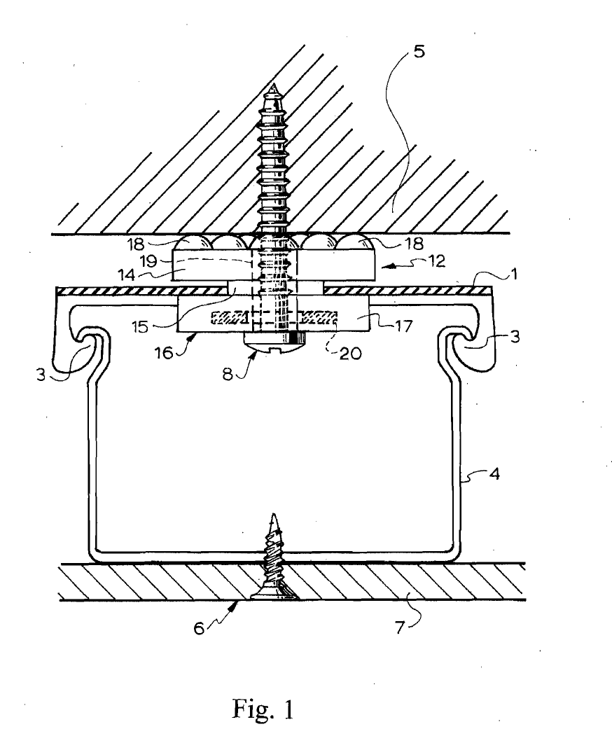

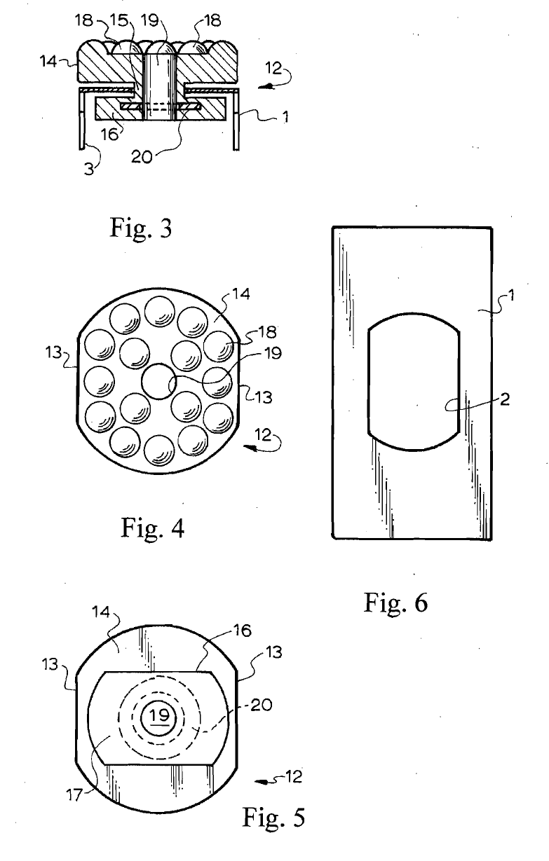

The support member 1 in the first embodiment of FIGS. 1 to 8 is a furring channel support bracket having hooked ears 3 to which a furring channel 4 (which is part of a second structure 6 of a building) can be coupled, but may be any other suitable support member. An aperture 2 is provided in the support member 1.

According to one embodiment of the present invention, a vibration dampening member 12 is provided as an integral moulded unit and has a first portion 14, neck 15 and second portion 16 comprising head 17. The first portion has protuberances 18 that abut with a first structure 5 of a building to help dampen vibrations. Head 17 has an embedded washer 20 and a centrally located bore 19 which runs through the vibration dampening member 12 and is suitable for receiving a fixing means such as a screw 8 or bolt which passes into the first structure 5 to secure the acoustic mount thereto. The washer 20 provides a hard surface against which the head of the screw or bolt 8 can abut or press when the mount is fixed to a wall or the like 5. Head 17 is generally rectangular with rounded ends and is complementary in size and shape to aperture 2, which is in the form of a slot.

The aperture 2 in one possible embodiment (not illustrated) is circular and head 17 can be slightly larger than the circular aperture 2 and made of resilient deformable material to be compressed and forced through the aperture 2 and, upon expansion after being forced through the aperture, resists withdrawal. A mushroom or arrow shaped profile may be suitable for head 17 in this instance.

Alternatively in the preferred embodiment illustrated, the aperture 2 is non-circular such as rectangular, triangular or other suitable shape with acute or rounded angles at its corners. In such case, head 17 is correspondingly sized and shaped. When the mount is assembled, the support member 1 is interposed between first portion 14 and head 17 of the vibration dampening member 12.

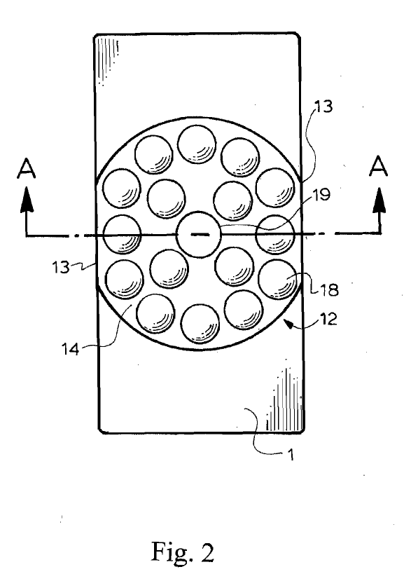

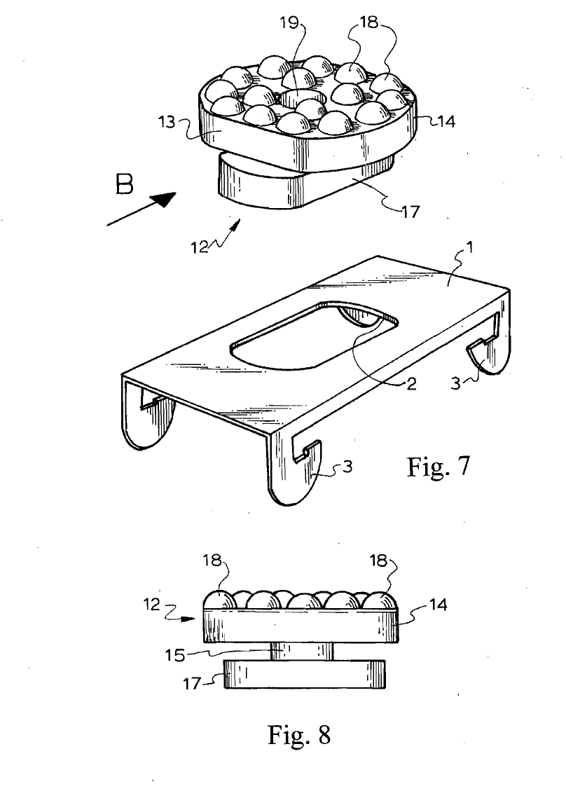

The mount shown in the drawings is easily assembled in one process. Head 17 is aligned with aperture 2 as shown in FIG. 7 and then passed through aperture 2 and then rotated 90° so that it resists withdrawal through aperture 3. The flat side edges 13 of the first portion 14 provide visual confirmation to a person assembling the mount when the head 17 is aligned with the rectangular aperture 2 (FIG. 7) and when the head is at 90° to the aperture 2 (FIG. 2).

The vibration dampening member 12 may be made of any suitable material such as rubber or thermoplastic polymer of the required hardness. The degree of hardness may depend in part upon the design of the head 17 and complementary aperture 2, particularly if compression of the head 17 is required to pass it through the aperture, as well as upon the vibration dampening properties required.

In use, as shown in FIG. 1, the mount comprises the assembly of the support member 1 and vibration dampening member 12. The vibration dampening member 12 is located in position against the first structure 5, which may be a structural building wall, and fastener screw 8 is passed into the bore 19 and driven into the structure 5. As the screw 8 is secured into the structure 5, the head of the screw 8 encounters resistance from the embedded washer 20, thereby limiting penetration of the screw into the structure 5. The second part of the structure 6 can then be assembled, as shown in the illustrated embodiment, by engaging furring channel 4 with the ears 3 of the support member 1. The facing panel 7 (e.g. plasterboard if internal, or cladding if external) of the second part of the structure 6 is mounted to the furring channel 4.

Vibrations, particularly from noise, will be dampened in passing between the first structure 5 and the second structure 6. This is primarily due to the fact that the acoustic mount comprises the connection point between the first structure 5 and the second structure 6. As can be seen, the support member 1, which is rigidly coupled to the second structure 6, has portions of the vibration dampening member 12 interposed between the first structure 5 and mounting screw 8. In particular, the first portion 14, which is made of resilient vibration dampening material, is interposed directly between the support member 1 and the structure 5. Similarly, the integral enlarged head 17, which is composed of the same resilient vibration dampening material, is interposed between the support member 1 and the fastening screw 8.

It will be appreciated that variations in the details of construction of the acoustic mount are possible without departing from the scope of the invention. As already mentioned, for example, the shape of the head and complementary shaped aperture can be varied from the generally rectangular shape shown in the drawings to other oblong shapes, or triangular shape, or other non-circular shapes, or to a bayonet like configuration with the head comprising an extension of the neck and having one or more projections extending laterally which can pass through complementary concavities at the profile of the aperture enabling the head to be inserted and then rotated so that the projections resist withdrawal.

The washer, instead of being embedded in the head in the moulding process of manufacture of the vibration dampening means, could be assembled e.g. by being adhered to the surface of the head with the aperture of the washer aligned with the bore through the vibration dampening means. The washer could be annular as illustrated or could be oblong in the case of an oblong head.

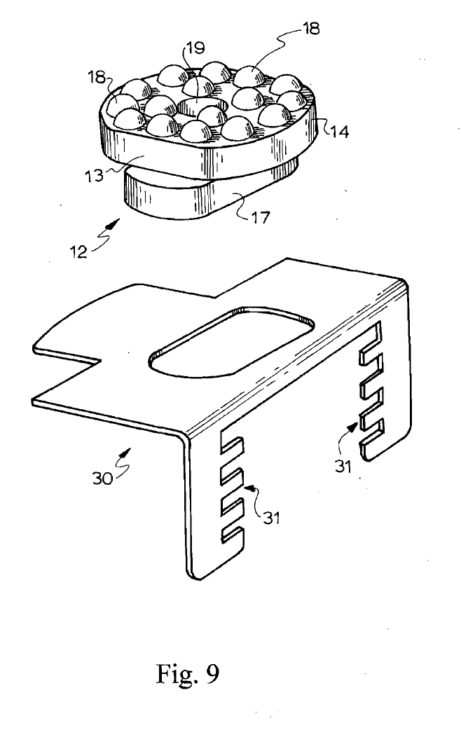

The acoustic mounts in FIGS. 9 to 11 exemplify other embodiments useable in the building industry.

FIG. 9 shows a different type of furring channel support member 30, as is known in the industry, which has spaced opposed lines of multiple support lugs 31 for supporting a furring channel in selectively variable positions.

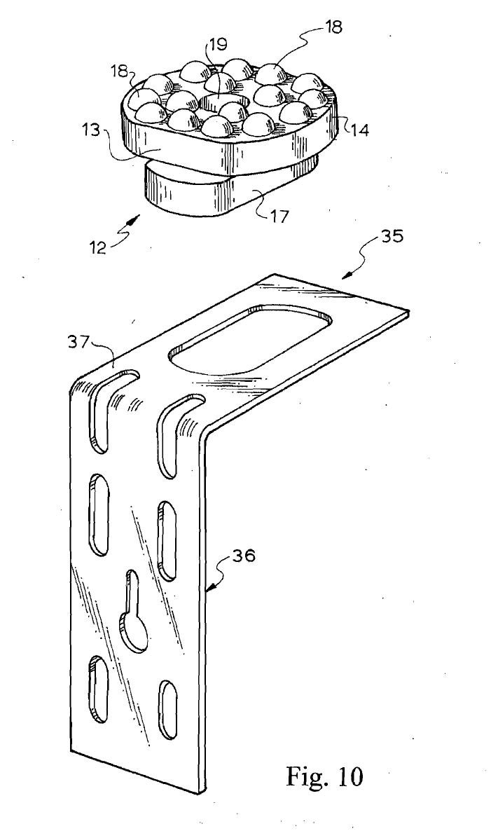

FIG. 10 shows an angle support member or bracket 35 having a leg 36 which can be mounted by screws etc to a first structure such as a structural wall, and an arm 37 at right angles for supporting or otherwise being coupled to another second structure, e.g. a floor at right angles to the first structure.

In both FIGS. 9 and 10 the vibration dampening member 12 is assembled with the support 30, 35 as in the first embodiment and functions in similar manner to isolate or insulate the connected structures from vibrations being transmitted through the connecting point.

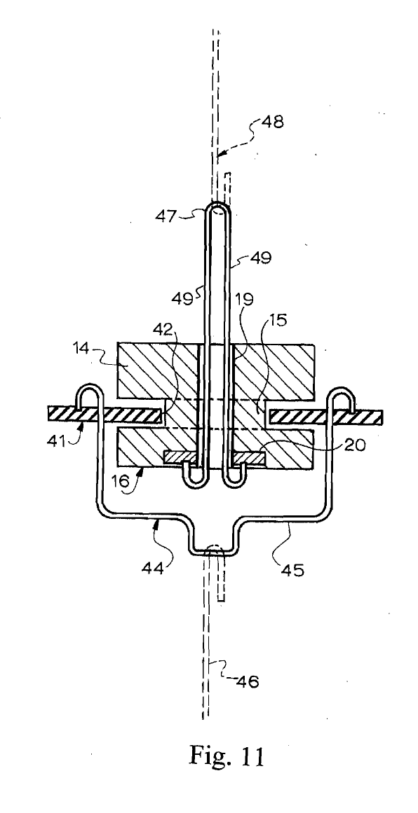

FIG. 11 shows an acoustic mount 40 for a suspension wire or suspension rod system, e.g. useable for a suspended ceiling system. The vibration dampening member 12 of the same construction as the first embodiment is coupled to a support member 41 having a central aperture 42 which receives the neck of the member 12. Support member 41 in turn has a wire 44 with a loop 45 to couple to a ceiling suspension rod 46. Another wire loop 47 is arranged to couple to upper suspension rod 48. The loop 47 has depending arms 49 that pass through the bore 19 and engage with washer 20. It will be seen that acoustic vibrations will not be transmitted between rods 46 and 48 because of the dampening member 12 that is interposed between those rods.

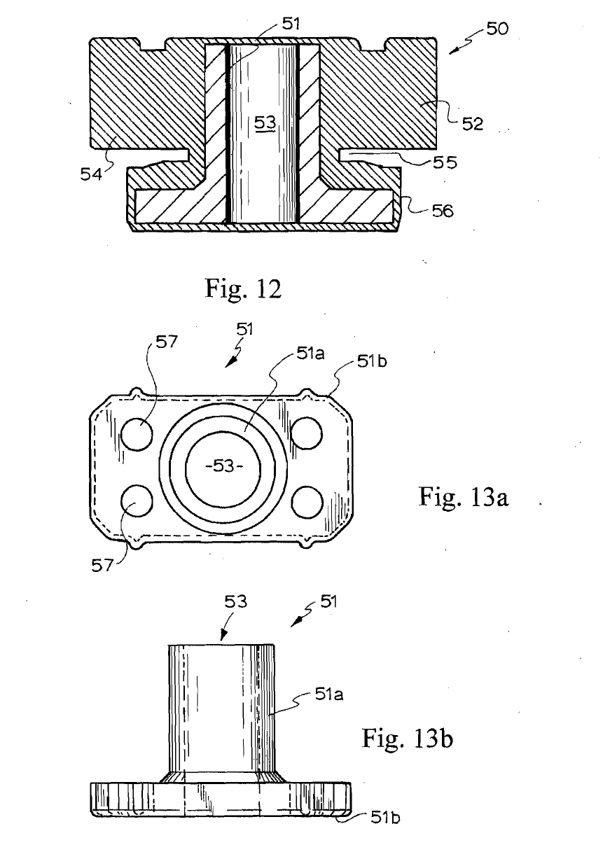

An alternative embodiment of a vibration dampening member suitable for use in an acoustic mount of the present invention is shown in FIG. 12 as reference numeral 50. As is the case with the dampening member 12 of the embodiment of FIG. 1, dampening member 50 is in the form of single body having an integral first portion 54, neck 55, and a second portion 56. The second portion 56 is in the form of a head that is shaped and sized to be passed through an aperture formed in a support member, in the manner as previously described.

The body of the dampening member 50 is formed by moulding a suitable dampening material, such as rubber or a thermoplastic polymer, about an inner receiver member 51, so as to form a member 50 of the desired shape, as shown. The body of the dampening member 50 thereby comprises an outer layer 52 of dampening material 52 formed about an inner receiver member 51, with the outer layer 52 and the inner member 51 being vulcanised together to form the dampening member 50. In this arrangement, the inner receiver member 51 is encapsulated within the outer layer 52 such that the member 51 is separable from the outer layer 52, only by destruction of the member 50.

The outer layer 52 of dampening material is moulded about the inner receiver member so as to form the first portion 54, neck 55, and second portion 56. One or more protuberances may be formed on the surface of the first portion 54 to abut with a surface of first structure of a building during use. Such an arrangement aids in dampening any vibrations that may transfer between the first portion 54 and the first structure of the building.

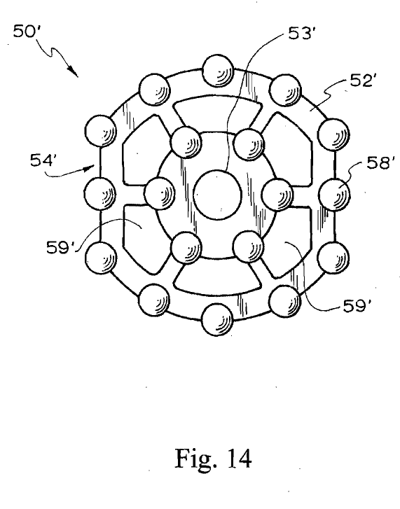

An alternative arrangement of the dampening member is shown in FIG. 14. In this arrangement, the outer layer 52′ of dampening material is moulded about the inner receiver member (not shown) to form the body of the dampening member 50′. The first portion 54′ is formed such that a plurality of void regions 59′ are formed therein and a plurality of protuberances 58′ are formed on the surface thereof. As in the previously described embodiment, the protuberances 58′ are provided to abut with a surface of the first structure of the building during use to facilitate dampening any vibrations that may transfer between the first portion 54 and the first structure of the building. The protuberances 58′ may have rounded ends or the ends may be flat or dimpled, as desired. The void regions 59′ provided between the protuberances 58′, further aid in this dampening function by reducing the weight and increasing the flexibility and surface area of the dampening member 50′. It will be appreciated that the embodiment of the dampening member 50′ as shown in FIG. 14 may also be employed in the mount arrangements shown in FIGS. 1-11.

The inner receiver member 51 is shown in more detail in FIGS. 13A and 13B, and comprises a substantially cylindrical body portion 51a and a head portion 51b. The body portion 51a extends orthogonally from the head portion 51b and has a bore 53 formed therein that extends through the body portion 51a and the head portion 51b as shown in FIG. 13B. Whilst the body portion 51a is shown as having a substantially circular bore 53, it will be appreciated that other bore 53 shapes are also envisaged.

Referring to FIG. 13A, the head portion 51b has a substantially rectangular shape with a plurality of through-holes 57 provided therethrough. The shape of the head portion 51b of the inner receiver member 51 generally determines the shape of the second portion 56 of the dampening member 50. In this regard, the outer layer 52 of dampening material is moulded about the head portion 51b. The provision of the through-holes 57 improves bonding between the layer of dampening material and the receiver member 51.

As shown in FIG. 12, when the dampening member 50 is formed by moulding the outer layer 52 of dampening material about the inner receiver member 51, the bore 53 of the inner receiver member 51 extends through the dampening member 50. As the inner receiver member 51 is made from a rigid metal or plastic material, the structural integrity of the dampening member 50 is significantly greater than that described in the previous embodiments. This is particularly so in those regions proximal the bore 53 and outer surface of the second portion 56, which are in direct contact with the fastening members that couple the first and second structures of the building. As such, the dampening material is able to experience significant forces without the rubber, or other such dampening material collapsing or deteriorating under load.

It will be appreciated that the dampening member 50 will be employed in a building or the like to dampen vibrations between structures in the manner as shown in FIG. 1 or FIG. 11, or any other such manner.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

When used in this specification and claims, the terms “comprises” and “comprising” and variations thereof mean that the specified features, steps or integers are included. The terms are not to be interpreted to exclude the presence of other features, steps or components.

It is to be understood that various alterations, modifications and/or additions may be made to the features of the possible and preferred embodiment(s) of the invention as herein described without departing from the spirit and scope of the invention.

We claim:

1. An acoustic mount for dampening vibrations between two structures mounted or coupled in use to each other, said mount comprising:
a vibration dampening member having a first portion, a neck and a second portion, said second portion comprising a head and said dampening member having a bore defined therein running through said first portion, neck and head to receive a fixing member for engaging or coupling to a first one of the two structures;
a support member to which a second one of the two structures is secured or coupled in use, said support member having an aperture defined therein to receive said dampening member; and
said dampening member being an integral unit and said head being passable through said aperture and positioned such that said head resisting withdrawal through the aperture and said support member being interposed between said first and second portions.

2. The mount of claim 1 wherein said aperture is non-circular and said head is shaped to pass through said aperture and then, upon rotation by less than 360°, to resist withdrawal through the aperture.

3. The mount of claim 1 wherein said first portion comprises a resilient pad to dampen vibration transmission therethrough between the first one of the two structures and the support member.

4. The mount of any one of claims 1, wherein said head has therein an embedded washer with a central hole aligned with the bore and the washer resists excessive travel of the fixing member through the bore during use of the mount.

5. The mount of claim 1, wherein the vibration dampening member has therein an embedded receiver member that extends between said first portion, neck and said second portion, said receiver member has a central bore defined therein that aligns with the bore of the vibration dampening member and a head portion that is received within the head of the second portion of the vibration dampening member, the head portion thereby resists excessive travel of the fixing member through the bore of the vibration dampening member during use of the mount.

6. The mount of claim 5, wherein the vibration dampening member comprises a vibration dampening material formed about the receiver member such that the receiver member is substantially encapsulated within the vibration dampening material.

7. The mount of claim 6, wherein the vibration dampening material is moulded about the receiver member.

8. The mount of claim 7, wherein the vibration dampening material is a polymeric material, and is formed about the receiver member through a process of vulcanisation.

9. The mount of claim 1 wherein said head is oblong in shape and said aperture is correspondingly shaped.

10. A method of assembling an acoustic mount, comprising:
providing a vibration dampening member and a support member, the vibration dampening member being an integral unit having a first portion, a neck, providing a second portion and a bore defined therein, said second portion comprising a head and said bore being adapted to receive a component running through said first portion, neck and second portion, and the support member having an aperture,
passing said head through the aperture and rotating said dampening member less than 360° around the axis of the bore such that said support member is being interposed between said first and second portions and said head resisting separation of the dampening member from the supported member.

11. A building structure having means for dampening sound vibrations travelling from a first structure of the building to a second structure of the building wherein said first and second structures are connected at connecting points, said building structure having at each of said connecting points an acoustic mount for dampening vibrations travelling between the first and second structures, said mount comprising:
a vibration dampening member having a first portion, a neck and a second portion, said second portion comprising a head, and said dampening member having a bore defined therein running through said first portion, neck and head receiving a component engaging or coupling to said first structure;
a support member to which said second structure is being secured or coupled, said support member having an aperture defined therein for receiving said dampening member;
said dampening member being an integral unit and said head having been passed through said aperture and positioned such that said head resisting withdrawal through the aperture and said support member being interposed between said portions, and
the component extending through said bore to engage or couple to said first structure, and said second structure being connected to said support member directly or indirectly.

12. A building structure as claimed in claim 11 wherein said first structure comprises a structural wall or floor of the building and said second structure comprises an internal wall or ceiling spaced from and mounted by the structural wall or floor.

13. A vibration dampening member, comprising:
a body having a first portion, a neck and a second portion, said second portion comprising a head and said body having a bore defined therein extending through said first portion, neck and head; and
a receiver member embedded within said body so as to extend between said first portion, neck and said second portion, said receiver member having a central bore defined therein that aligns with the bore of the body and a head portion that is embedded within the head of the second portion of the body.

14. A vibration dampening member according to claim 13, wherein the body comprises a vibration dampening material formed about the receiver member such that the receiver member is substantially encapsulated within the vibration dampening material.

15. A vibration dampening member according to claim 14, wherein the vibration dampening material is moulded about the receiver member.

16. A vibration dampening member according to claim 15, wherein the vibration dampening material is a polymeric material, and is formed about the receiver member through a process of vulcanisation.

17. A vibration dampening member according to claim 13, wherein the receiver member comprises a cylindrical portion that extends transverse to said head portion so as to extend through said neck and first portion of the body.
